(19) United States
(12) Patent Application Publication
(10) Pub. No.: US 2018/0123267 A1
(43) Pub. Date: May 3, 2018

(54) PRESS-FIT TERMINAL

(71) Applicant: Sumitomo Wiring Systems, Ltd., Yokkaichi, Mie (JP)

(72) Inventor: Hideki Goto, Yokkaichi, Mie (JP)

(21) Appl. No.: 15/567,422

(22) PCT Filed: Mar. 9, 2016
(86) PCT No.: PCT/JP2016/057355

§ 371 Date: Oct. 18, 2017

(30) Foreign Application Priority Data
Apr. 22, 2015 (JP) 2015-087643

(51) Int. Cl. H01R 12/58; H01R 13/03; H01R 43/16; H01B 5/02

(52) U.S. Cl. CPC H01R 12/585; H01B 5/02; H01R 43/16; H01R 13/03

(57) ABSTRACT

Provided is a press-fit terminal configured to secure a warp of press-contact portions and reduce insertion force required to insert the press-contact portion into the through hole, without increasing the number of components and manufacturing costs. In a press-fit terminal one end portion of a Rod-Shaped Metal Member (“RSMM”) is provided with press-contact portions configured to be press-fitted into a through hole of a printed board and electrically connected to a conductor, and the other end portion of the rod-shaped metal member includes a connection portion configured to be connected to a partner member, the one end portion of the RSMM has: squashed portions; and the press-contact portions that protrude outward from the squashed portions, and each press-contact portion is configured to deform in a circumferential direction of the RSMM due to contact pressure applied when the press-contact portions are pressed against the through hole.

### CROSS-REFERENCE TO RELATED APPLICATIONS

This application is the U.S. national stage of PCT/JP2016/057355 filed Mar. 9, 2016, which claims priority of Japanese Patent Application No. JP 2015-087643 filed Apr. 22, 2015.

### TECHNICAL FIELD

The present invention relates to a press-fit terminal that is press fitted into a through hole of a printed board, and is thus electrically connected to a conductor applied to an inner surface of the through hole.

### BACKGROUND

Conventionally, a connection terminal is used to electrically connect a circuit conductor provided on a board such as a printed board, to a partner member such as a connector. A so-called press-fit terminal, which is disclosed in JP 2004-127610A, for example, is known as such a connection terminal. In such a press-fit terminal, one end portion of a rod-shaped metal member is provided with a press-contact portion that is springy, whereas the other end portion of the rod-shaped metal member is provided with a connection portion that is to be connected to a partner member. The press-contact portion is press-fitted into, and is fixed to, a through hole of a board. Thus, it is possible to electrically connect the press-fit terminal to a conductor that is exposed in the through hole, and fix the press-fit terminal to the board, without using a solder.

As discussed in JP 2004-127610A, press-fit terminals are formed by stamping a metal plate. Then, a pair of arch-shaped press-contact portions are formed by punching a through hole in a central area of one end portion of a rod-shaped metal member. Such a pair of press-contact portions are formed so as to be elastically deformable in a direction that is orthogonal to the axis, and thus the rod-shaped metal member is provided with springiness.

However, many connection terminals are extremely small and have a width or a plate thickness of less than 1 mm. It is difficult to process such a terminal to form press-contact portions that have the above-described structure, and this is a cause of an increase in manufacturing costs. In addition, since both ends of each arch-shaped press-contact portion are connected to the terminal, it is difficult to secure a sufficient amount of warp. Therefore, it is inevitable that a strong insertion force is applied when the press-contact portions are inserted into the through hole, and there is also the risk of the press-contact portions shaving the inner surface of the through hole and producing metal shavings.

Considering the problems above, the inventor of the present invention previously proposed in JP 2013-149578A a press-fit terminal that includes a rod-shaped metal member, which is longitudinally rod-shaped, and press-contact portions that are formed by bringing a metal material, which is separate from the rod-shaped metal member, into press-contact with the rod-shaped metal member such that the metal material wraps around one end portion of the rod-shaped metal member. With this configuration, the rod-shaped metal member and the press-contact portions are formed using separate components, and therefore flexibility improves when manufacturing press-contact portions, and it becomes possible to advantageously form press-contact portions that have sufficient springiness (amount of warp) even if the plate thickness of the rod-shaped metal member is small. Therefore, it is possible to reliably bring the press-contact portion into press-contact with a through hole while reducing the insertion force that is applied when the press-contact portions are inserted into the through hole. Also, it is possible to prevent the problem in which the press-contact portions shave the inner surface of the through hole.

However, since the press-contact portions are formed by bringing a metal material, which is separate from the rod-shaped metal member, into press-contact with the rod-shaped metal member such that the metal material wraps around one end portion of the rod-shaped metal member, there is still room for improvement in terms of suppressing an increase in the number of components and manufacturing costs, and further improved press-fit terminals have been developed.

The present invention has been made in view of the above-described situation, and a problem to be solved by the invention is to provide a press-fit terminal that has a novel structure that makes it possible to secure an amount of warp of press-contact portions and reduce insertion force that is applied when the press-contact portions are inserted into the through hole, while suppressing an increase in the number of components and manufacturing costs.

### SUMMARY

A first aspect of the present invention is a press-fit terminal in which one end portion of a rod-shaped metal member is provided with press-contact portions that are to be press-fitted into a through hole of a printed board and electrically connected to a conductor on an inner surface of the through hole, and the other end portion of the rod-shaped metal member is provided with a connection portion that is to be connected to a partner member, wherein the one end portion of the rod-shaped metal member has: squashed portions that are provided by performing press-forging on portions of a surface of the one end portion; and the press-contact portions that are formed as portions that protrude outward in a domed shape due to the squashed portions being provided, each press-contact portion is configured to deform to warp in a circumferential direction of the rod-shaped metal member due to contact pressure that is applied when the press-contact portions are pressed against the through hole, and a depth of each squashed portion gradually decreases toward both ends of the rod-shaped metal member in an axial direction, and a length of a protrusion of each press-contact portion decreases toward both ends of the rod-shaped metal member in the axial direction.

According to this aspect, the press-contact portions are formed as portions that protrude outward due to the squashed portions being provided by performing press-forging on portions of a surface of the one end portion of the rod-shaped metal member. Therefore, it is unnecessary to form the press-contact portions using a conventional metal member that is separate from the rod-shaped metal member, and hence it is possible to reduce the number of components and manufacturing costs. In particular, since it is possible to form the press-contact portions by simply performing press-forging to provide the squashed portions, it is easier to perform processing compared to the case of forming a through hole, even if the required width of the press-fit terminal is small. Therefore, it is possible to suppress an increase in manufacturing costs or the like. Furthermore, according to this aspect, the depth of the squashed portions is largest at a central portion of the rod-shaped metal member in the axial direction, and gradually decrease toward both sides. Therefore, the protruding length of the press-contact portions that protrude outward due to the squashed portions being provided also gradually decreases towards both ends in the axial direction, and thus the outer surfaces of the protruding portions are formed so as to have a tapered shape. Therefore, it is possible to smoothly perform an operation to insert the press-fit terminal into the through hole, and thus it is possible to improve workability at the time of insertion.

Also, the press-contact portions protrude outward in a cantilever-like shape from the surface of the rod-shaped metal member, and when press-fitted into the through hole, the press-contact portions deform to warp in the circumferential direction of the rod-shaped metal member due to contact pressure. Therefore, it is easier to secure a sufficient amount of warp, and hence it is possible to reduce the insertion force that is applied when the press-contact portions are inserted into the through hole, while securing desired springiness.

Moreover, since the press-contact portions deform to warp in the circumferential direction of the rod-shaped metal member when press-fitted into the through hole, compressing stresses of the contact portions are prevented from interfering with each other in a direction that is orthogonal to the axial direction of the rod-shaped metal member, and it is possible to more reliably reduce the insertion force.

A second aspect of the present invention is the press-fit terminal according to the first aspect, wherein the rod-shaped metal member is formed by cutting a rectangular metal wire to a predetermined length, a plating layer is applied to a surface of the rectangular metal wire, a pair of squashed portions are provided as the squashed portions in at least one pair of opposing surfaces of the rod-shaped metal member, and a pair of press-contact portions are provided as the press-contact portions at at least one pair of diagonal positions of the rod-shaped metal member.

According to this aspect, it is possible to easily form the rod-shaped metal member by cutting a rectangular metal wire. Also, it is possible to stably form the squashed portions by performing press-forging on the pair of opposing surfaces of the rectangular metal wire from both sides. Furthermore, since the press-contact portions are provided on the pair of corner portions, the press-contact portions protrude outward in an advantageous manner. Therefore, it is possible to advantageously form the press-fit terminal according to the present aspect, while reducing manufacturing costs.

Moreover, since plating has been applied to the surface of the rectangular metal wire in advance, it is unnecessary to perform post-plating processing on the press-contact portions, unlike in the case of conventional stamping processing. Therefore, it is possible to further reduce costs.

A third aspect of the present invention is the press-fit terminal according to the first or second aspect, wherein, in a cross section along a direction that is orthogonal to an axial direction of the rod-shaped metal member, each squashed portion includes a first oblique side and a second oblique side that is longer than the first oblique side.

According to this aspect, since the first oblique side and the second oblique side of each squashed portion have different lengths, it is possible that central axes that extend in protruding directions of the press-contact portions that protrude outward due to the squashed portions do not intersect the central axis of the rod-shaped metal member. With this configuration, when the press-contact portions are press-fitted into the through hole, force components that press the press-contact portions in the circumferential direction are generated, which allow the press-contact portions to deform to warp in the circumferential direction.

A fifth aspect of the present invention is the press-fit terminal according to any one of the first to fourth aspects, wherein the rod-shaped metal member has a rectangular cross section, the squashed portions are provided by performing press-forging on two pairs of opposing surfaces of the rod-shaped metal member, and the press-contact portions that protrude outward and are each configured to deform to warp in the circumferential direction of the rod-shaped metal member are formed at both pairs of diagonal positions of the rod-shaped metal member due to the squashed portions being provided.

According to this aspect, since the squashed portions are provided by performing press-forging on two pairs of opposing surfaces of the rod-shaped metal member that has a rectangular cross section, it is possible to easily provide four press-contact portions that are each configured to deform to warp in the circumferential direction of the rod-shaped metal member, on the four corner portions of the rod-shaped metal member. With this configuration, the press-fit terminal is pressed into and fixed to the through hole using the four press-contact portions that are separated from each other in the circumferential direction. Therefore, it is possible to more reliably bring the press-contact portions into press-contact with the through hole, and it is possible to further reduce the insertion force that is applied when the press-contact portions are inserted into the through hole.

A sixth aspect of the present invention is the press-fit terminal according to the second aspect, wherein the rectangular metal wire is made of a copper alloy.

According to this aspect, the rectangular metal wire is made of a copper alloy. With this configuration, it is possible to advantageously form the press-contact portions that are configured to deform to warp in the circumferential direction of the rod-shaped metal member. Note that examples of the copper alloy include phosphor bronze and C194, which have excellent springiness.

### Advantageous Effects

According to the present invention, the press-contact portions are formed as portions that protrude outward by providing the squashed portions. Therefore, it is unnecessary to form the press-contact portions using a conventional metal member that is separate from the rod-shaped metal member, and hence it is possible to reduce the number of components and manufacturing costs. Also, it is easier to perform processing compared to the case of forming a through hole, even if the required width of the press-fit terminal is small. Therefore, it is possible to suppress an increase in manufacturing costs or the like. Furthermore, the press-contact portions protrude outward in a cantilever-like shape from the surface of the rod-shaped metal member, and when press-fitted into the through hole, the press-contact portions deform to warp in the circumferential direction of the rod-shaped metal member due to contact pressure. Therefore, it is easier to secure a sufficient amount of warp, and hence it is possible to reduce the insertion force that is applied when the press-contact portions are inserted into the through hole, while securing desired springiness. Moreover, since the press-contact portions deform to warp in the circumferential direction of the rod-shaped metal member, compressing stresses of the contact portions are prevented from interfering with each other in a direction that is orthogonal to the axial direction of the rod-shaped metal member, and it is possible to more reliably reduce the insertion force.

### BRIEF DESCRIPTION OF DRAWINGS

FIG. 1 is a perspective view showing a press-fit terminal, which is a first embodiment of the present invention.

FIG. 2 is a front view of FIG. 1.

FIG. 3 is an enlarged perspective view of a main part of a cross section along III-III in FIG. 1, and illustrates a manufacturing method according to the present embodiment ((a) at the time of punching, (b) after punching).

FIG. 4 is an enlarged view of a main part of a cross section along IV-IV in FIG. 2, and illustrates a manufacturing method according to the present embodiment ((a) at the time of punching, (b) after punching).

FIG. 5 is a front view showing a situation where the press-fit terminal according to the present embodiment is provided so as to stand on a printed board.

FIG. 6 is an enlarged view of a main part of a cross section along VI-VI in FIG. 5.

FIG. 7 is a perspective view showing a press-fit terminal, which is a second embodiment of the present invention.

FIG. 8 is a front view of FIG. 7.

FIG. 9 is a front view showing a situation where the press-fit terminal according to the present embodiment is provided so as to stand on a printed board.

FIG. 10 is an enlarged view of a main part of a cross section along X-X in FIG. 9.

FIG. 11 is an enlarged cross-sectional view of a main part that shows a press-fit terminal, which is a third embodiment of the present invention, and corresponds to FIGS. 6 and 10.

### DETAILED DESCRIPTION OF PREFERRED EMBODIMENTS

The following describes embodiments of the present invention with reference to the drawings.

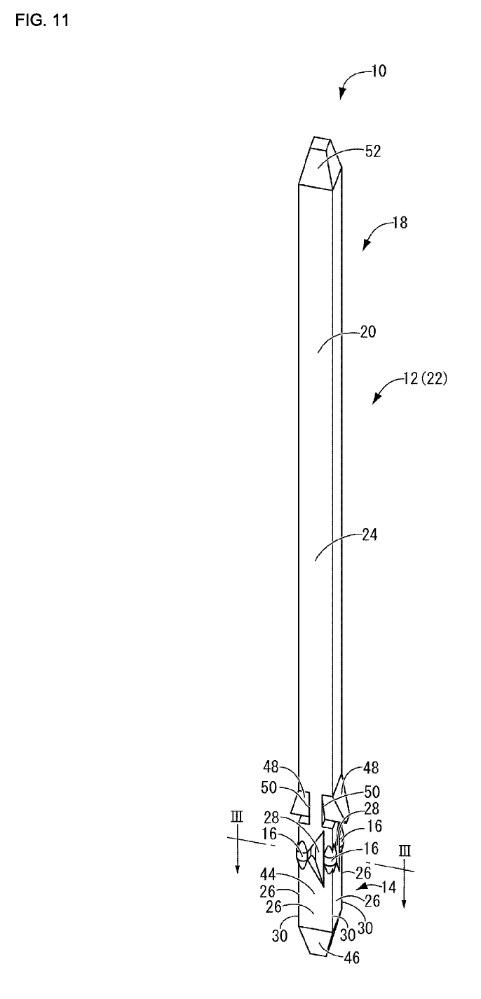

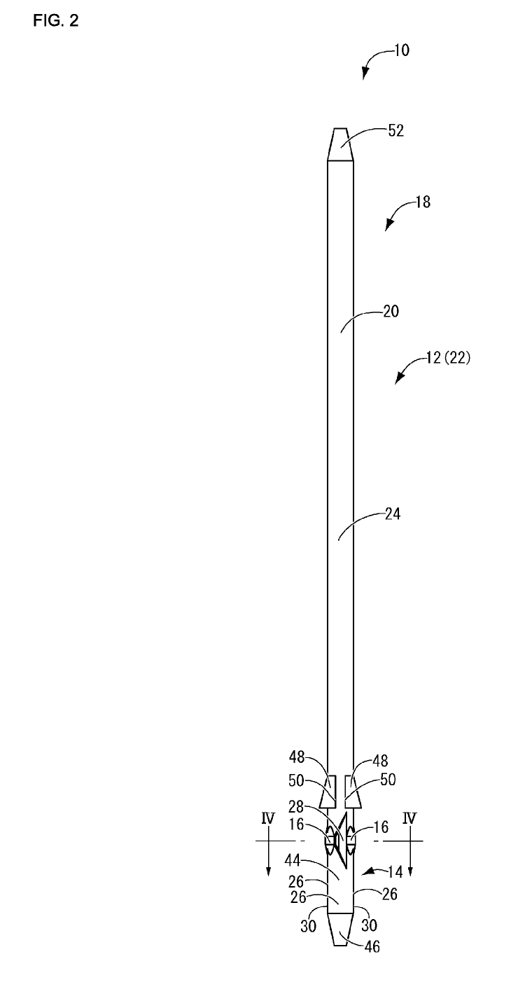

First, FIGS. 1 and 2 show a press-fit terminal 10, which is a first embodiment of the present invention. The press-fit terminal 10 is an integrally molded part in which press-contact portions 16 are formed in one end portion 14 of a rod-shaped metal member 12, and a connection portion 20 is formed in the other end portion 18 of the rod-shaped metal member 12. Note that, in the following description, “lengthwise direction” and “top-bottom direction” refer to the top-bottom direction in FIG. 2, and “widthwise direction” refers to the left-right direction in FIG. 2. Also, “plate-thickness direction” refers to a direction that is orthogonal to the drawing sheet of FIG. 2.

The rod-shaped metal member 12 is formed by cutting a rectangular metal wire 22 to a predetermined length. Preferably, a rectangular metal wire that is rigid enough to undergo shape processing to impart springiness is employed as the rectangular metal wire 22. For example, the rectangular metal wire 22 is a wire that is made of a copper alloy with excellent springiness, such as phosphor bronze or C194, and extends with a constant cross section that has a substantially square shape. A plating layer 24 is applied to the entire circumferential surface of the rectangular metal wire 22. The plating layer 24 is formed by, for example, laminating tin plating or the like on base plating of copper, nickel, or the like.

The press-contact portions 16 are formed in the one end portion 14 of the rod-shaped metal member 12 that has been cut out of such a rectangular metal wire 22. The press-contact portions 16 are formed as portions that protrude outward from both pairs of diagonal positions, namely, four corner portions 30 of the rod-shaped metal member 12 due to squashed portions 28 being formed by pressure-forging the two pairs of opposing surfaces 26 of the rod-shaped metal member 12 that has a substantially square cross-sectional shape.

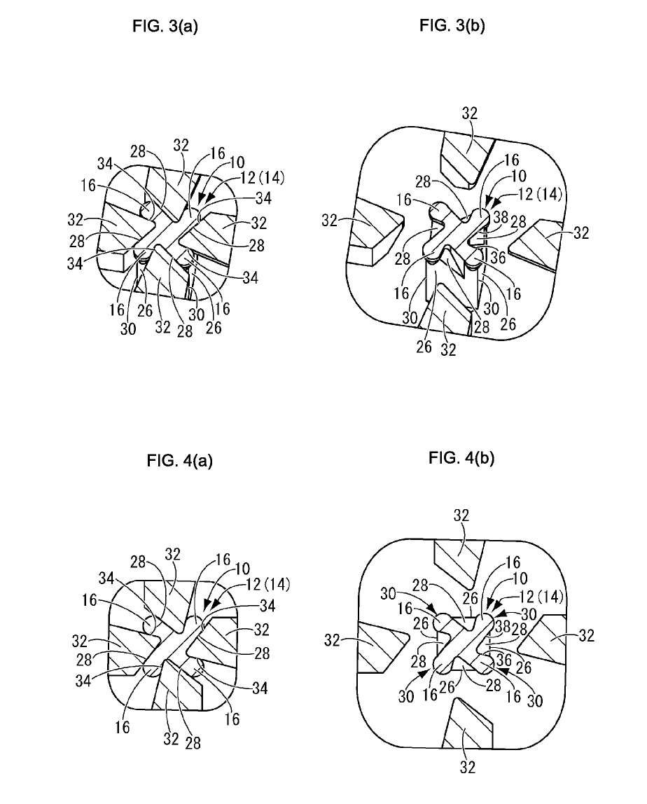

As shown in FIGS. 3 and 4, which illustrate cross sections along a direction that is orthogonal to the axial direction of the rod-shaped metal member 12, the press-contact portions 16 are formed by simultaneously pressing four punches (dies) 32 that have the same shape, against the two pairs of opposing surfaces 26, namely four opposing surfaces 26 of the one end portion 14 of the rod-shaped metal member 12 that has a substantially square cross-sectional shape, to perform press-forging on the four opposing surfaces 26. More specifically, as shown in FIGS. 3(a) and 4(a), portions that have been pushed away to the sides of the punches 32 due to the punches 32 being pressed against the four opposing surfaces 26 of the rod-shaped metal member 12, are pushed out to gaps 34 between adjacent punches 32, and thus the press-contact portions 16 are formed. Also, the punches 32 are asymmetric with respect to directions in which the punches 32 are pressed against the opposing surfaces 26 of the rod-shaped metal member 12, and therefore the squashed portions 28 each include a first oblique side 36 and a second oblique side 38 that is longer than the first oblique side 36 (see FIGS. 3(b) and 4(b)). Furthermore, as shown in FIGS. 1 and 2, the squashed portions 28 are recessed portions that each have a substantially triangular pyramid shape, and the depth of each squashed portion 28 gradually decreases toward both ends of the rod-shaped metal member 12 in the axial direction (the top-bottom direction). In contrast, the press-contact portions 16 are protruding portions that each have a substantially domed shape, and the length of the protrusion of each press-contact portion 16 gradually decreases toward both ends of the rod-shaped metal member 12 in the axial direction (the top-bottom direction).

In the one end portion 14 of the rod-shaped metal member 12, a portion that is closer to the front side (the lower side in FIGS. 1 and 2) than the press-contact portions 16 is provided with an insertion portion 44 that protrudes downward. Also, as in conventional terminals, a front end tapered portion 46, which is tapered, is formed at an edge portion of the insertion portion 44.

Also, in the rod-shaped metal member 12, a portion that is closer to the center side (the upper side in FIG. 2) than the press-contact portions 16 in the lengthwise direction (the top-bottom direction in FIG. 2) is provided with a pair of board contact portions 48. The pair of board contact portions 48 have a configuration in which both side portions in the widthwise direction, which are closer to the center, are partially cut apart from a central portion in the widthwise direction, which is closer to the center, due to a pair of slits 50 being provided in the thickness direction so as to extend in a substantially L-like shape, with the upper edges of the side portions being coupled to the connection portion 20. The pair of board contact portions 48 are formed by bending up the lower edges of both widthwise side portions so as to protrude in the opposite directions in the plate thickness direction.

Furthermore, the connection portion 20 is formed in the other end portion 18 of the rod-shaped metal member 12. Also, as in conventional terminals, a rear end tapered portion 52, which is tapered, is formed at an edge portion of the connection portion 20.

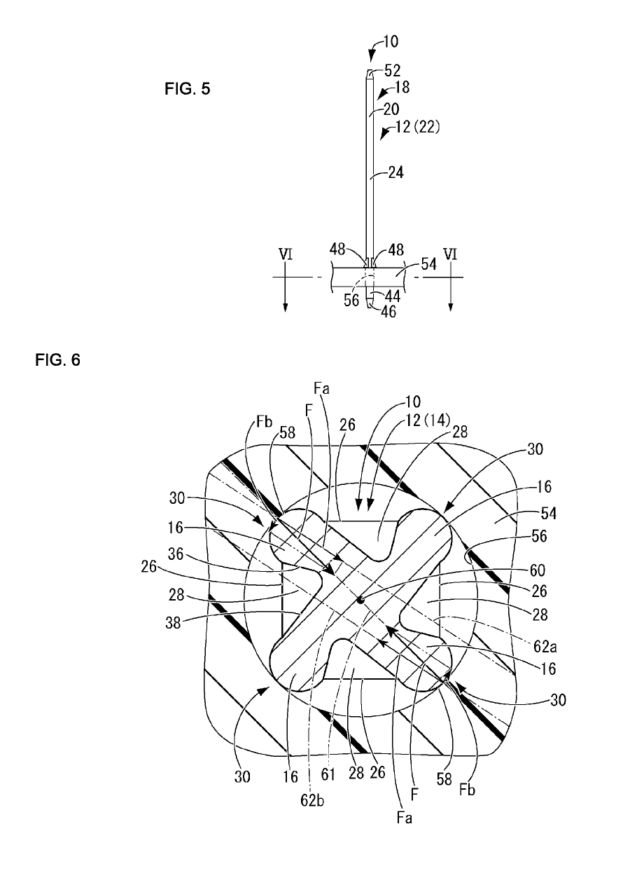

The press-fit terminal 10 with such a configuration is inserted into a through hole 56 of a printed board 54 from the insertion portion 44 as shown in FIG. 5. Here, the amount of insertion of the press-fit terminal 10 into the through hole 56 is determined by the board contact portions 48 abutting against the printed board 54. Thus, the press-contact portions 16 are press-fitted into the through hole 56, and, as shown in FIG. 6, end surfaces 58 of the press-contact portions 16 are pressed toward a central axis 60 of the rod-shaped metal member 12 in a direction along a pressing axis 61 due to contact pressure that is applied when the press-contact portions 16 are pressed against the through hole 56 at the time of such press-fitting. Since the first oblique side 36 and the second oblique side 38 of each squashed portion 28 have different lengths, central axes 62a and 62b, which extend in protruding directions of the press-contact portions 16 that protrude outward due to the squashed portions 28, do not intersect the central axis 60 of the rod-shaped metal member 12. With this configuration, pressing forces F that are applied to the end surfaces 58 of the press-contact portions 16 as a result of the above-described press-fitting can be divided into, as shown in FIG. 6, compressing forces Fa that compress the press-contact portions 16 in the directions along the central axes 62a and 62b and rotational forces Fb that press the press-contact portions 16 in a circumferential direction (the counterclockwise direction in FIG. 6). Due to rotational forces Fb, the press-contact portions 16 deform to warp in the circumferential direction of the rod-shaped metal member 12. As a result, due to the elastic restoring forces of the press-contact portions 16 in the directions along the central axes 62a and 62b and the circumferential direction, the end surfaces 58 of the press-contact portions 16 are brought into press-contact with the through hole plating layer (not shown) that is formed as a conductor on the inner surface of the through hole 56. As a result, the press-fit terminal 10 is fixed to the printed board 54 with the connection portion 20 protruding, the press-contact portions 16 are electrically connected to the through hole plating layer, and a partner member such as a connector (not shown) is connected to the connection portion 20. Note that the directions in which the compressing forces Fa are applied to each pair of press-contact portions 16 that are opposite with respect to the central axis 60 of the rod-shaped metal member 12 do not interfere with each other as indicated by the central axes 62a and 62b in FIG. 6, and therefore such a configuration contributes to a reduction in the insertion force.

In the press-fit terminal 10 with such a configuration, the press-contact portions 16 protrude from the corner portions 30 of the rod-shaped metal member 12 due to the squashed portions 28 being formed in the one end portion 14 of the rod-shaped metal member 12 by performing press-forging on the opposing surfaces 26 of the rod-shaped metal member 12. Therefore, it is unnecessary to form the press-contact portions 16 using a conventional metal member that is separate from the rod-shaped metal member 12, and hence it is possible to reduce the number of components and manufacturing costs. Moreover, since it is possible to form the press-contact portions 16 by simply forming the squashed portions 28 by performing press-forging on the opposing surfaces 26 of the rod-shaped metal member 12, it is easier to perform processing compared to the case of forming a conventional through hole, even if the required width of the press-fit terminal 10 is small. Therefore, it is possible to suppress an increase in manufacturing costs or the like.

In addition, according to the present embodiment, it is possible to easily form the rod-shaped metal member 12 by cutting the rectangular metal wire 22, and to stably form the squashed portions 28 by performing press-forging on each pair of opposing surfaces 26 of the rectangular metal wire 22 from both sides. Furthermore, since the press-contact portions 16 are provided on the corner portions 30, the press-contact portions 16 protrude outward in an advantageous manner. Moreover, since the plating layer 24 is applied to the surface of the rectangular metal wire 22, it is unnecessary to perform post-plating processing on the press-contact portions 16, unlike in the case of conventional stamping processing. Therefore, it is possible to further reduce costs.

The press-contact portions 16 protrude outward in a cantilever-like shape from the surface of the rod-shaped metal member 12, and when press-fitted into the through hole 56, the press-contact portions 16 deform to warp in the circumferential direction of the rod-shaped metal member 12 due to contact pressure. Therefore, it is easier to secure a sufficient amount of warp of the press-contact portions 16, and hence it is possible to reduce the insertion force that is applied when the press-contact portions 16 are inserted into the through hole 56, while securing desired springiness. Moreover, using the rod-shaped metal member 12 that has been cut out of the rectangular metal wire 22 that has a substantially square cross-sectional shape, it is possible to easily provide the four corner portions 30 of the rod-shaped metal member 12 with the four press-contact portions 16 that can deform to warp in the circumferential direction of the rod-shaped metal member 12 by performing press-forging on the opposing surfaces 26 to form the squashed portions 28. Therefore, it is possible to more reliably bring the press-contact portions 16 into press-contact with the through hole 56, and it is possible to further reduce the insertion force that is applied when the press-contact portions 16 are inserted into the through hole 56.

Furthermore, since the depth of the squashed portions 28 gradually decreases toward both ends of the rod-shaped metal member 12 in the axial direction (the top-bottom direction), the press-contact portions 16, which protrude outward due to the squashed portions 28 being formed, are realized as substantially domed protrusions whose protruding length gradually decreases toward both ends in the axial direction. Therefore, it is possible to smoothly perform an operation to insert the press-fit terminal 10 into the through hole 56, and thus it is possible to improve workability at the time of insertion.

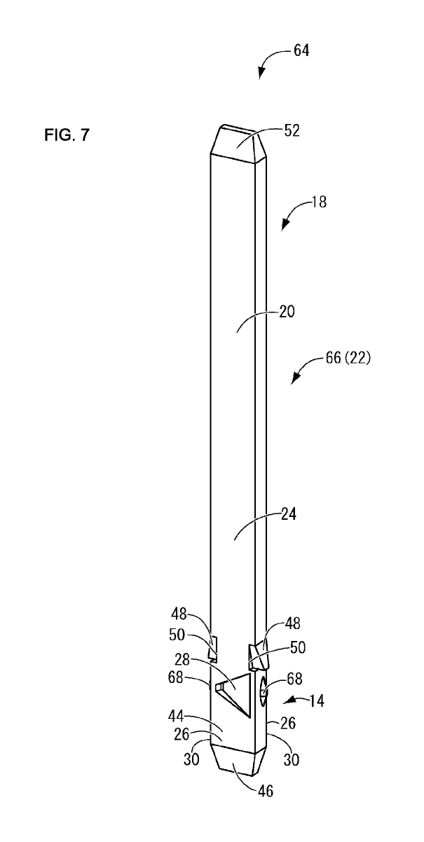

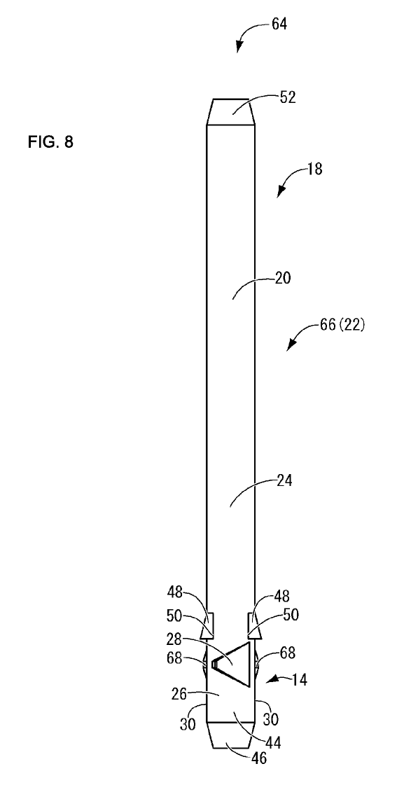

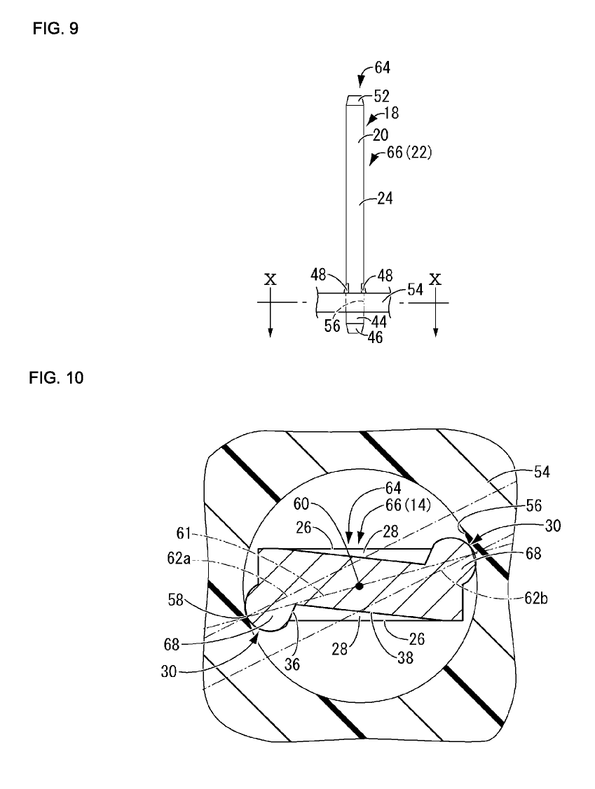

Next, a press-fit terminal 64, which is a second embodiment of the present invention, will be described in detail with reference to FIGS. 7 to 10. In these drawings, members and portions that have the same configurations as those in the above-described embodiment are assigned the same reference numerals as those in the above-described embodiment, and detailed descriptions thereof are omitted. The press-fit terminal 64 is formed by stamping a metal plate that is made of, for example, a copper alloy with excellent springiness, such as phosphor bronze or C194, the surface of which is plated with tin or the like. The press-fit terminal 64 is an embodiment that is different from the first embodiment in that the press-fit terminal 64 is formed using a rod-shaped metal member 66 that has a substantially strip-like flat shape as a whole. That is, in the press-fit terminal 64 according to the present embodiment, press-contact portions 68 are formed in the one end portion 14 of the rod-shaped metal member 66 as portions that protrude outward from diagonal positions, namely, two corner portions 30 of the rod-shaped metal member 66 due to the squashed portions 28 being formed by pressure-forging a pair of opposing surfaces 26 that are opposite in the plate thickness direction (a direction that is orthogonal to the drawing sheet of FIG. 8). Therefore, as with the above-described first embodiment, it is unnecessary to form the press-contact portions 68 using a conventional metal member that is separate from the rod-shaped metal member 66, and hence it is possible to reduce the number of components and manufacturing costs.

Also, in the press-fit terminal 64 according to the present embodiment, as shown in FIG. 10, the press-contact portions 68 are formed so as to protrude outward in a cantilever-like shape from the two corner portions 30 of the rod-shaped metal member 66. Moreover, in the press-contact portions 68, as in the above-described first embodiment, the first oblique side 36 and the second oblique side 38 of each squashed portion 28 have different lengths, and therefore the central axes 62a and 62b, which extend in protruding directions of the press-contact portions 68 do not intersect the central axis 60 of the rod-shaped metal member 66. As a result, when the press-contact portions 68 are press-fitted into the through hole 56, the press-contact portions 68 deform to warp in the circumferential direction of the rod-shaped metal member 66 due to the contact pressure. Therefore, as with the above-described first embodiment, it is easier to secure a sufficient amount of warp of the press-contact portions 68, and hence it is possible to reduce the insertion force that is applied when the press-contact portions 68 are inserted into the through hole 56, while securing desired springiness.

Furthermore, in the press-fit terminal 64 according to the present embodiment, as shown in FIG. 7, as in the above-described first embodiment, the depth of the squashed portions 28 gradually decreases toward both ends of the rod-shaped metal member 66 in the axial direction (the top-bottom direction), and therefore the press-contact portions 68, which protrude outward due to the squashed portions 28 being formed, are realized as substantially domed protrusions whose protruding length gradually decreases toward both ends in the axial direction. Therefore, as with the above-described first embodiment, it is possible to smoothly perform an operation to insert the press-fit terminal 64 into the through hole 56, and thus it is possible to improve workability at the time of insertion.

Although embodiments of the present invention have been described above, the present invention is not limited to the specific descriptions of the embodiments in any manner. For example, although the press-contact portions 16 in the above-described first embodiment are formed at both pairs of diagonal positions of the rod-shaped metal member 12 due to the squashed portions 28 being formed by pressure-forging the two pairs of opposing surfaces 26 of the rod-shaped metal member 12, the press-contact portions 16 may be formed at only one pair of diagonal positions of the rod-shaped metal member 12 due to the squashed portions 28 being formed by pressure-forging one pair of opposing surfaces 26 of the rod-shaped metal member 12.

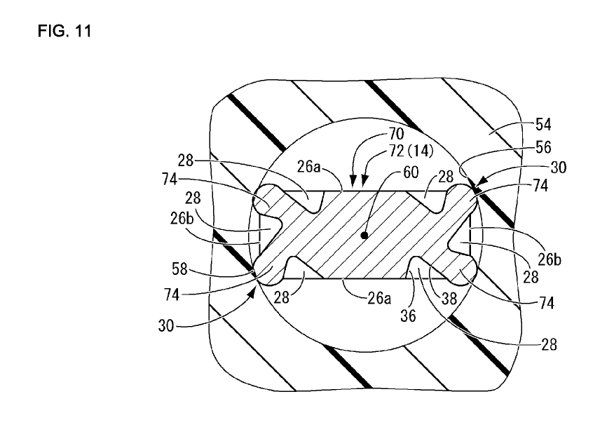

Furthermore, as shown in FIG. 11, in a rod-shaped metal member 72, which has a substantially rectangular cross section, of a press-fit terminal 70, which is a third embodiment of the present invention, it is possible that, in each of a pair of wider opposing surfaces 26a, squashed portions 28 that have substantially the same shape as those in the first embodiment are provided in both end portions in the widthwise direction such that the squashed portions 28 are point-symmetric with respect to the central axis 60 of the rod-shaped metal member 72, whereas, in each of a pair of narrower opposing surfaces 26b, a squashed portion 28 that has substantially the same shape as those in the first embodiment is provided in a central portion such that the squashed portions 28 are point-symmetric with respect to the central axis 60 of the rod-shaped metal member 72. With such a configuration, it is possible to advantageously form elongated press-contact portions 74 that protrude from the four corner portions of the rod-shaped metal member 72 that has a substantially rectangular cross section, and it is possible to more advantageously secure the springiness of the press-contact portions 74.

1. A press-fit terminal in which one end portion of a rod-shaped metal member is provided with press-contact portions that are to be press-fitted into a through hole of a printed board and electrically connected to a conductor on an inner surface of the through hole, and the other end portion of the rod-shaped metal member is provided with a connection portion that is to be connected to a partner member,
wherein the one end portion of the rod-shaped metal member has: squashed portions that are provided by performing press-forging on portions of a surface of the one end portion;
and the press-contact portions that are formed as portions that protrude outward in a domed shape due to the squashed portions being provided;
each press-contact portion is configured to deform to warp in a circumferential direction of the rod-shaped metal member due to contact pressure that is applied when the press-contact portions are pressed against the through hole, and
a depth of each squashed portion gradually decreases toward both ends of the rod-shaped metal member in an axial direction, and a length of a protrusion of each press-contact portion decreases toward both ends of the rod-shaped metal member in the axial direction.

2. The press-fit terminal according to claim 1,
wherein the rod-shaped metal member is formed by cutting a rectangular metal wire to a predetermined length,
a plating layer is applied to a surface of the rectangular metal wire,
a pair of squashed portions are provided as the squashed portions in at least one pair of opposing surfaces of the rod-shaped metal member, and
a pair of press-contact portions are provided as the press-contact portions at at least one pair of diagonal positions of the rod-shaped metal member.

3. The press-fit terminal according to claim 1,
wherein, in a cross section along a direction that is orthogonal to an axial direction of the rod-shaped metal member, each squashed portion includes a first oblique side and a second oblique side that is longer than the first oblique side.

4. (canceled)

5. The press-fit terminal according to claim 1,
wherein the rod-shaped metal member has a rectangular cross section, the squashed portions are provided by performing press-forging on two pairs of opposing surfaces of the rod-shaped metal member, and the press-contact portions that protrude outward and are each configured to deform to warp in the circumferential direction of the rod-shaped metal member are formed at both pairs of diagonal positions of the rod-shaped metal member due to the squashed portions being provided.

6. The press-fit terminal according to claim 2,
wherein the rectangular metal wire is made of a copper alloy.

7. The press-fit terminal according to claim 2, wherein, in a cross section along a direction that is orthogonal to an axial direction of the rod-shaped metal member, each squashed portion includes a first oblique side and a second oblique side that is longer than the first oblique side.

8. The press-fit terminal according to claim 2, wherein the rod-shaped metal member has a rectangular cross section, the squashed portions are provided by performing press-forging on two pairs of opposing surfaces of the rod-shaped metal member, and the press-contact portions that protrude outward and are each configured to deform to warp in the circumferential direction of the rod-shaped metal member are formed at both pairs of diagonal positions of the rod-shaped metal member due to the squashed portions being provided.

9. The press-fit terminal according to claim 3, wherein the rod-shaped metal member has a rectangular cross section, the squashed portions are provided by performing press-forging on two pairs of opposing surfaces of the rod-shaped metal member, and the press-contact portions that protrude outward and are each configured to deform to warp in the circumferential direction of the rod-shaped metal member are formed at both pairs of diagonal positions of the rod-shaped metal member due to the squashed portions being provided.
